(19) United States
(12) Patent Application Publication
(10) Pub. No.: US 2002/0194887 A1
(43) Pub. Date: Dec. 26, 2002

(54) Structure of a latch bolt

(76) Inventor: Wen Kwei Chang, Taipei (TW)

Correspondence Address: Wen-Kwei Chang, PO Box 82-144, TAIPEI, TW

(21) Appl. No.: 09/886,093

(22) Filed: Jun. 22, 2001

(51) Int. Cl. E05B 67/06

(52) U.S. Cl. 70/38 B; 70/49

(57) ABSTRACT

An improved structure of a torsional force activated latch bolt is disclosed. The latch bolt has a body including a hook hole, a latch hole and a bolt hole, the hook hole allowing the insertion of a buttoning head, the latch hole allowing the mounting with a latch and the bolt hole being provided with a latch bolt and a spring, characterized in that the rear end of the latch bolt is connected with a torsional spring, and the latch bolt is torsionally actuated by the exertion force of the torsional spring such that a notch of the latch bolt is engaged with a circular slot of the buttoning head forming a locking position, or by means of an actuating block of the latch urges the latch bolt to torsionally actuate in a reverse position such that the notch of the latch bolt to disengage from the circular slot of the buttoning head forming an unlocking position.

### BACKGROUND OF THE INVENTION

(a) Field of the Invention

The present invention relates to a latch bolt, and in particular, an improved structure of a latch bolt employing a torsional spring so that the latch bolt can only rotate but cannot move either in a left or in a right direction.

(b) Description of the Prior Art

Taiwanese Patent Publication No. 204681, entitled “Steel Cable Lockset Structure” discloses a lockset having a housing, a cylindrical tube, a latch hole, a bolthole and a fastening hole. The front end of the latch bolt is provided with a slot hole and the two lateral sides of the latch bolt are formed into a pair of clipping legs. The clipping legs are engaged with the neck portion of a buttoning head so that the lockset is provided with a better fastening structure.

Taiwanese Patent Publication No. 409763 relates to a padlock with replaceable latch and hook comprising a body, a latch, a core and a U-shaped hook.

In view of the conventional art, a spring is compressed to urge a single latch bolt and the front end slanting face of the latch bolt can be engaged with a circular slot at the neck portion of the buttoning head so that a steel cable with the body forms a locking position. The drawback of this single latch bolt is that the lockset can be easily forced to open by impact for the reason that the spring force of the lockset is provided by a compression spring to urge the slanting face at the front end of the latch bolt to engage with the circular slot of the neck portion of the buttoning head to form a locking position. Thus, the locking position can be easily unlocked by an external impact to the lockset.

### SUMMARY OF THE INVENTION

Accordingly, it is an object of the present invention to provide an improved structure of a torsional force activated latch bolt having a body including a hook hole, a latch hole and a bolt hole, the hook hole allowing the insertion of a buttoning head, the latch hole allowing the mounting with a latch and the bolt hole being provided with a latch bolt and a spring, characterized in that the rear end of the latch bolt is connected with a torsional spring, and the latch bolt is torsionally actuated by the exertion force of the torsional spring such that a notch of the latch bolt is engaged with a circular slot of the buttoning head forming a locking position, or by means of an actuating block of the latch to urge the latch bolt to actuate in a reverse position such that the notch of the latch bolt is disengaged from the circular slot of the buttoning head for ring an unlocking position.

Yet another object of the present invention is to provide an improved structure of a latch bolt, wherein the drawbacks of the conventional latch structure are overcome and new features and advantages are provided to the bolt latch of the present invention.

Other objects and advantages of the present invention will become more apparent from the following description taken in conjunction with the accompanying drawing.

### BRIEF DESCRIPTION OF THE DRAWINGS

FIG. 1 a perspective exploded view of latch bolt structure of the present invention.

FIG. 2 is a schematic view illustrating interior parts of the latch bolt at a locking position in accordance with the present invention.

FIG. 3 is a sectional view along line 3-3 of FIG. 2.

FIG. 4 is a schematic view illustrating interior parts of the latch bolt at an unlocking position in accordance with the present invention.

FIG. 5 is a sectional view along line 5-5 of FIG. 4.

### DETAILED DESCRIPTION OF THE PRESENT INVENTION

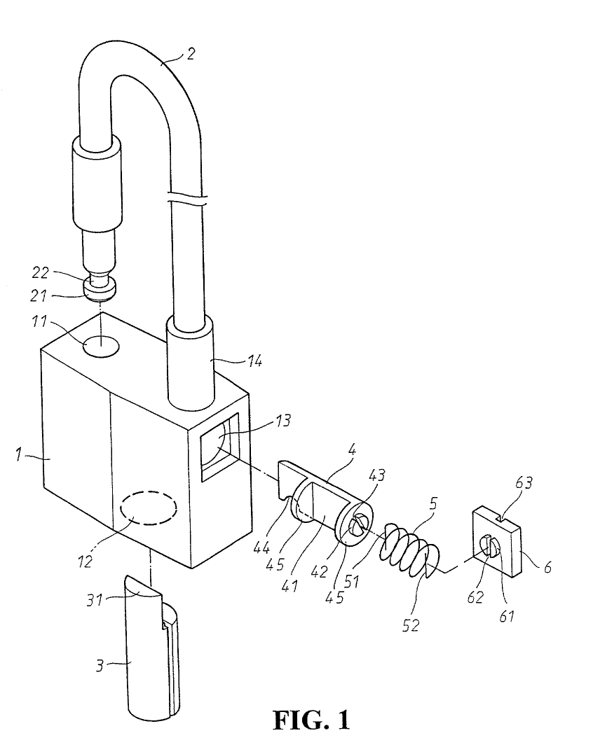

Referring to FIG. 1, there is shown an improved structure of a latch bolt, comprising a body 1 having a hooking hole 11, a latch hole 12 and a bolt hole 13, wherein the hook hole 11 and the bolt hole 13 are perpendicular and are in communication with each other. The latch hole 12 and the bolthole 13 are also perpendicular to each other and are in communication with each other.

The hooking hole 11 allows a buttoning head 21 mounted onto a flexible steel cable 2 to be inserted therein. One end of the steel cable 2 is riveted to the buttoning head 21, and the other end of the steel cable 2 is riveted to the cylindrical body of the latch bolt.

The latch hole 12 is used for the mounting of the latch 3 such that when the latch 3 is driven with a key, the latch 3 can be rotationally positioned within the latch hole 12. The top end of the latch 3 is provided with an actuating block 31, and the actuating block 31 is extended into an arch-shaped slot 41 of the latch bolt 4.

The bolthole 13 allows the insertion of the latch bolt 4 and the torsional spring 5. The rear end of the latch bolt 4 is provided with a protrusion 42 having a slot 43 at the center thereof for the mounting of the leg 51 at one end of the torsional spring 5.

The other leg 52 at the other end of the torsional spring 5 can be mounted to the slot 62 of the protrusion 61 on the cap 6. The cap 6 is forced to cover the opening of the bolthole 13 tightly.

The surface of the cap 6 is provided with another slot 63 for the engagement of a flat-shaped tool so that the cap 6 can be rotated for a certain degree so as to forcefully mount the opening of the bolthole 13. Thus, by means of the cap 6 to tightly rotate the torsional spring 5, the spring 5 is provided with a greater torsional force to exert a force on the latch bolt 4.

The shape of the cap 6 is preferably not circular, and the opening of the bolthole 13 must comply with the shape of the cap 6 such that the cap 6 can be forced into the bolthole 13 and the torsional spring 5 will not become loose in the case of a reverse rotation.

In addition, the front end of the latch bolt 4 is provided with a notch 44 which can be engaged with the externally mounted circular slot 22 at the buttoning head 21 of the steel cable 2 such that the steel cable 2 and the body 1 both form into a locking position.

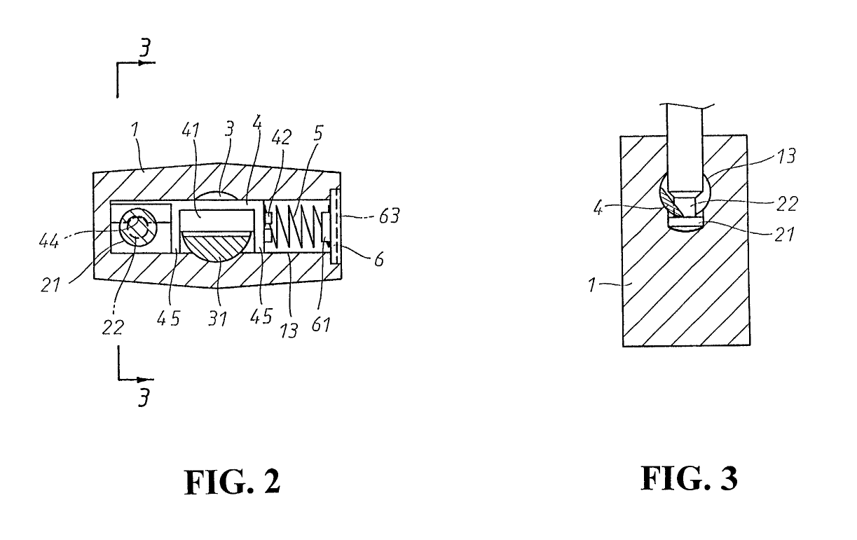

Referring to FIGS. 2 and 3, there is shown the locking of the latch bolt of the present invention.

In normal situation, the latch bolt 4 is acted by the torsional force of the spring 5 and the notch 44 at the front end of the latch bolt 4 is driven to rotate to a certain angle. Thus, when the buttoning head 21 of the steel cable 2 is inserted into the interior of the hook hole 11, the notch 44 of the latch bolt 4 can be engaged with the circular slot 22 of the buttoning head 21 such that the buttoning head 21 is fastened to the hook hole 11. Thus, a locking position is obtained.

When at the locking position, the actuating block 31 at the top end of the latch 3 is protruded to the arch-shaped slot 41 of the latch bolt 4 such that the latch bolt 4 and the actuating block 31 both form an engagement. That is, when at the locking position, the wall 45 at the two lateral sides of the arch-shaped slot 41 respectively urge the two lateral sides of the actuating block 31 to form an engagement. Thus, the actuating block 31 blocks the latch bolt 4 and the latch bolt 4 cannot move to either the left or right direction. This avoids the buttoning head 21 from disengagement when an external force impacts the latch bolt 4.

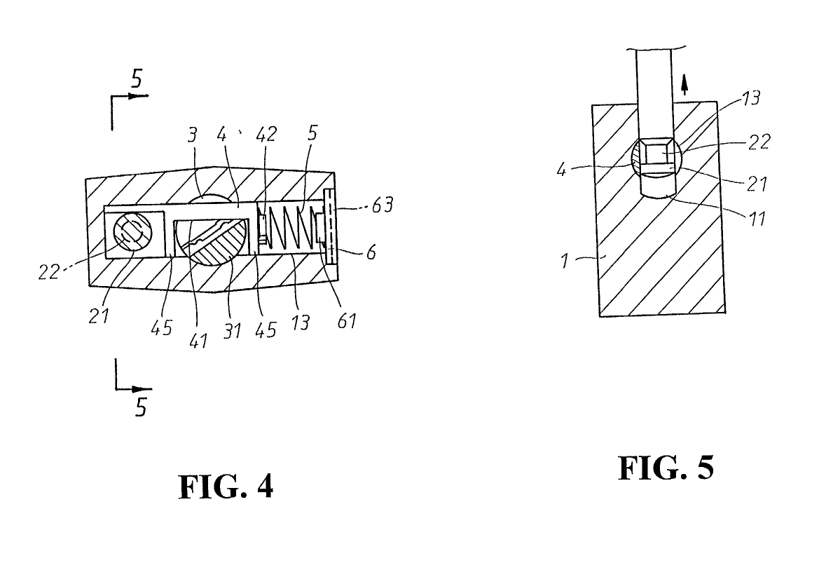

Referring to FIGS. 4 and 5, there is shown the unlocking of the latch bolt of the present invention.

When a key is inserted into the latch 3 to drive the latch 3 together with the actuating block 31 to rotate, the actuating block 31 forcefully urges the arch-shaped slot 41 of the latch bolt 4 to rotate such that the latch bolt 4 rotates as a result of the urging force. Thus, the notch 44 at the front end of the latch bolt 4 is disengaged from position at the circular slot 22 of the buttoning head 21. Thus, the buttoning head 21 can be disengaged from the hook hole 11 to form an unlocking position.

In view of the above, the mutual action of the latch bolt 4 and the torsional spring 5 causes the latch bolt 4 to only torsionally rotate but not left and right movement, and a locking and/or unlocking position of the latch bolt is obtained. By means of the actuating block 31 and the arch-shaped slot 41 of the latch bolt 4, the latch bolt 4 cannot move either in a left or a right position. Thus, the buttoning head 21 of the steel cable will not be disengaged or loosened as a result of an impact external force.

While the invention has been described with respect to preferred embodiment, it will be clear to those skilled in the art that modifications and improvements may be made to the invention without departing from the spirit and scope of the invention. Therefore, the invention is not to be limited by the specific illustrative embodiment, but only by the scope of the appended claims.

I claim:

1. An improved structure of a torsional force activated latch bolt having a body including a hook hole, a latch hole and a bolt hole, the hook hole allowing the insertion of a buttoning head, the latch hole allowing the mounting with a latch and the bolt hole being provided with a latch bolt and a spring, characterized in that the rear end of the latch bolt is connected with a torsional spring, and the latch bolt is actuated by the exertion force of the torsional spring such that a notch of the latch bolt is engaged with a circular slot of the buttoning head forming a locking position, or by means of an actuating block of the latch to urge the latch bolt to torsionally actuate in a reverse position such that the notch of the latch bolt to disengage from the circular slot of the buttoning head forming an unlocking position.

2. The improved structure of a torsional force activated latch bolt of claim 1, wherein the latch bolt is provided with an arch-shaped slot having two lateral walls adjacently urging the two lateral sides of the actuating block of the latch.

3. The improved structure of a torsional force activated latch bolt of claim 1, wherein one end of the latch bolt is provided with a protrusion having a slot and the path provides mounting with the leg of the torsional spring.

4. The improved structure of a torsional force activated latch bolt of claim 1, wherein an opening position of the bolt hole is provided with a cap, and a protrusion is provided on the cap having a slot for the mounting with the leg of the torsional spring.

5. The improved structure of a torsional force activated latch bolt of claim 1, wherein the surface of the cap is provided with a slot.

6. The improved structure of a torsional force activated latch bolt of claim 1, wherein the shape of the bolthole is not circular.
